(19) United States
(12) Patent Application Publication
(10) Pub. No.: US 2005/0026126 A1
(43) Pub. Date: Feb. 3, 2005

(54) Method for students to carry out chemical reactions

(76) Inventor: James H. Hageman, Mount Pleasant, MI (US)

Correspondence Address: MCKELLAR STEVENS & HILL PLLC, POSEYVILLE PROFESSIONAL COMPLEX, 784 SOUTH POSEYVILLE ROAD, MIDLAND, MI, 48640, US

(21) Appl. No.: 10/630,171

(22) Filed: Jul. 30, 2003

(51) Int. Cl. G09B 23/24

(52) U.S. Cl. 434/298

(57) ABSTRACT

An improved method for students to carry out and observe chemical reactions by mixing a fluid reactant with a reactive component to produce a reaction product. The improvement is the provision of a package fabricated of upper and lower sheet material defining at least a first closed chamber containing a first fluid reactant and an adjacent second closed chamber containing a reactive component, the package formed by sealing the upper sheet material to the lower sheet material at the periphery of the chambers so that when the first chamber is pressed, then the first fluid reactant will break the seal between the first and second chambers and flow into the second chamber to react with the reactive component in the second chamber to produce an observable reaction product or condition. For example, the fluid reagent can be a dilute aqueous solution of sodium chloride and the reactive component can be a dilute aqueous solution of silver nitrate, the silver nitrate reacting with the sodium chloride to form silver chloride precipitate which is easily observed by the student through the flexible sheet material.

### BACKGROUND

The instant invention relates to educating students, such as high school or introductory college students, in the field of chemical sciences. More specifically, the instant invention is in the field of systems for allowing students to carry out chemical reactions in a relatively safe, small-volume, sealed system.

Conduction of chemical reactions by students can be a valuable aspect of learning chemistry. Thus, students may conduct chemical reactions in the classroom or in a laboratory. However, students conducting such reactions are potentially liable to chemical exposure caused by handling, spills or breakage of containers because such reactions are generally conducted in open glass containers. In addition, teachers are typically required to have access to a laboratory area, to maintain required chemical storage areas in accordance with a chemical hygiene plan, to prepare necessary solutions for conducting experiments or for demonstrating reactions and to dispose of waste chemicals in a proscribed manner. Therefore, it would be an advance in the educational process if safer, simpler systems were developed to allow students to directly carry out and observe chemical reactions in a classroom setting.

U.S. Pat. No. 3,348,921 disclosed a safer, large scale system for demonstrating chemical reactions comprising reservoirs, conduits and flasks molded into a rigid transparent body. However, the system of the '921 patent required filling reservoirs with liquid reactants and used an open container.

U.S. Pat. No. 3,036,894 disclosed a system for conducting chemical reactions comprising a hollow body formed from pliable sheet material internally divided to provide a series of spaced apart closed chambers with selected testing substances enclosed in the chambers and an open initial chamber into which a test material was introduced. The initial chamber was then closed and squeezed (such as by passing the open end of the hollow body into squeeze rollers) to pressurize the initial chamber to break the seal between the initial chamber and the first closed chamber so that the test material mixed and reacted with the testing substance in the first closed chamber. The system of the '894 patent would be safer for students to demonstrate chemical reactions but at a minimum would still expose the student to the material introduced into the first open chamber.

### SUMMARY OF THE INVENTION

The instant invention allows an active, discovery-based process for student learning while being a solution, to a large degree, to the above stated problems of student exposure to chemical reagents, of the maintenance of a chemical laboratory and a chemical stockroom, of the preparation of reagents and of the disposal of reacted chemicals and the disposal of surplus reagents. In the instant invention, all components are sealed in chambers formed between upper and lower sheet material during the manufacturing process. Neither the student nor the teacher is confronted with an open system. The seal between the chambers is weaker than the seal around the remainder of the chambers so that when a fluid reagent chamber is pressed by the student, the fluid reagent flows into an adjacent chamber containing a component that reacts with the fluid reagent. For example, the fluid reagent can be a dilute aqueous solution of sodium chloride and the reactive component can be a dilute aqueous solution of silver nitrate, the silver nitrate reacting with the sodium chloride to form silver chloride precipitate which is easily observed by the student through the sheet material.

More specifically, the instant invention is an improved method for allowing students to carry out and observe chemical reactions by mixing a fluid reactant with a reactive component to produce a reaction product, wherein the improvement comprises the step of: providing a package fabricated of upper and lower sheet material defining at least a first closed chamber containing a first fluid reactant and an adjacent second closed chamber containing a reactive component, the package formed by sealing the upper sheet material to the lower sheet material at the periphery of the chambers so that when the first chamber is pressed, then the first fluid reactant will break the seal between the first and second chambers and flow into the second chamber to react with the reactive component in the second chamber to produce a reaction product.

In another embodiment, the instant invention is an improved method for demonstrating chemical reactions to a student by mixing a fluid reactant with a fluid reactive component to produce a reaction product, wherein the improvement comprises the step of: providing a package fabricated of upper and lower sheet material defining at least a first closed chamber containing a first fluid reactant, a second closed chamber containing a first fluid reactive component, the first closed chamber and the second closed chamber each being adjacent a third closed chamber, the package formed by sealing the upper sheet material to the lower sheet material at the periphery of the chambers, at least the upper sheet material being flexible so that when the first chamber is pressed, then the first fluid reactant will break the seal between the first and the third chambers and flow into the third chamber and so that when the second chamber is pressed, then the first fluid reactive component will break the seal between the second and third chambers and flow into the third chamber to react with the first fluid reactant in the third chamber to produce a reaction product, the reaction product to be observed by the student through the package.

In yet another embodiment, the instant invention is an article of manufacture, comprising a package fabricated of upper and lower sheet material defining at least a first closed chamber containing a first fluid reactant and an adjacent second closed chamber containing a reactive component, the package formed by sealing the upper sheet material to the lower sheet material at the periphery of the chambers, at least the upper sheet material being flexible so that when the first chamber is pressed, then the first fluid reactant will break the seal between the first and second chambers and flow into the second chamber to react with the reactive component in the second chamber to produce a reaction product, the reaction product selected from the group consisting of a colored acid/base indicator, and a precipitate.

In another embodiment, the instant invention is an article of manufacture, comprising a a package fabricated of upper and lower sheet material defining at least a first closed chamber containing a first fluid reactant, a second closed chamber containing a first fluid reactive component, the first closed chamber and the second closed chamber each being adjacent a third closed chamber, the package formed by sealing the upper sheet material to the lower sheet material at the periphery of the chambers, at least the upper sheet material being flexible so that when the first chamber is pressed, then the first fluid reactant will break the seal between the first and the third chambers and flow into the third chamber and so that when the second chamber is pressed, then the first fluid reactive component will break the seal between the second and third chambers and flow into the third chamber to react with the first fluid reactant in the third chamber to produce a reaction product, the reaction product, the reaction product selected from the group consisting of a colored acid/base indicator, and a precipitate.

### BRIEF DESCRIPTION OF THE DRAWINGS

FIG. 1 shows a side cross-sectional view of a package used in the instant invention fabricated of upper and lower flexible sheet material defining a first closed chamber containing a first fluid reactant and an adjacent second closed chamber containing a reactive component, the package formed by sealing the upper flexible sheet material to the lower flexible sheet material at the periphery of the chambers;

FIG. 2 shows a top view of the package of FIG. 1;

FIG. 3 shows a top view of a package used in the instant invention having five peripheral reagent chambers and a central reaction chamber useful, for example, in demonstrating titrations;

FIG. 4 shows a top view of a package used in the instant invention having three successive chambers useful, for example, in demonstrating a two step reaction;

FIG. 5 shows a top view of a package used in the instant invention having three reagent chambers adjacent an elongated reaction chamber useful, for example, for the observation of a diffusion process;

FIG. 6 shows a top view of a package used in the instant invention having instructions printed thereon;

FIG. 7 shows a side view of a process for filling vacuum formed depressions in a flexible sheet material with a fluid reactant and a fluid reactive component;

FIG. 8 shows a side view of a process for sealing the flexible sheet material of FIG. 7 to a relatively rigid sheet material to produce a package to be provided in the instant invention;

FIG. 9 shows the package of FIG. 8 being used by a student to carry out a chemical reaction; and

FIG. 10 shows a process for making packages to be used in the instant invention from tube sections.

### DETAILED DESCRIPTION OF THE INVENTION

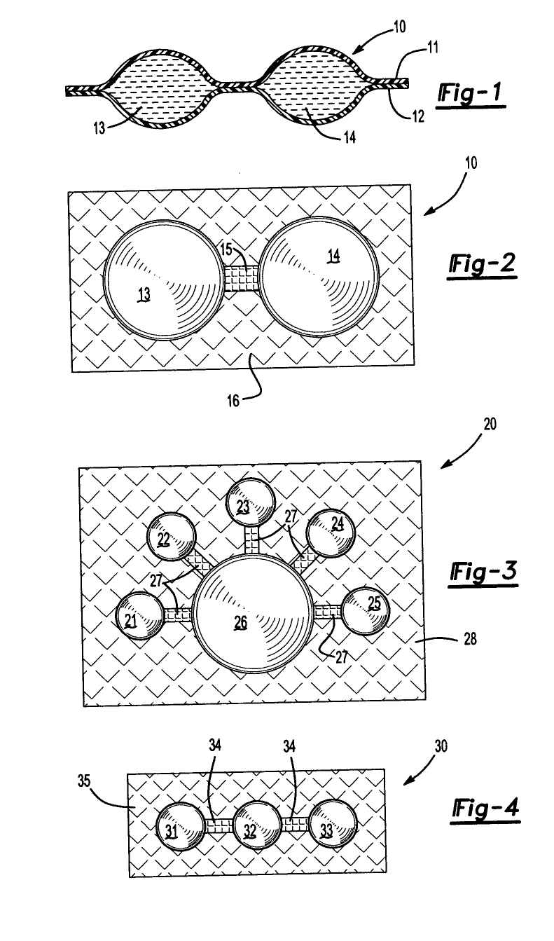

Referring now to FIG. 1, therein is shown a side cross-sectional view of a package 10 to be provided in the instant invention comprised of an upper layer 11 and lower layer 12 of flexible transparent Surlyn brand thermoplastic sheet material from DuPont (E. I. du Pont de Nemours and Company, Wilmington, Del.). The upper layer 11 and the lower layer 12 define a first closed chamber 13 containing a dilute solution of sodium chloride. The upper layer 11 and the lower layer 12 also define a second closed chamber 14 containing a dilute solution of silver nitrate.

Referring now also to FIG. 2, therein is shown a top view of the package 10 of FIG. 1. The chambers 13 and 14 are formed by sealing the upper layer 11 to the lower layer 12 at the periphery of the chambers. However, the strength of the seal between the layers 11 and 12 between the chambers 13 and 14 is weaker than the strength of the seal between the layers 11 and 12 of the remaining portion of the package 10. Referring specifically to FIG. 2, the relatively weaker seal between the chamber 13 and 14 is indicated by the smaller cross-hatching 15 while the relatively stronger remaining seal is indicated by the larger cross-hatching 16. When the first chamber 13 is pressed (for example, by pressing the chamber 13 by pressure between the fingers of a student) then the dilute sodium chloride in the chamber 13 breaks the seal between the chamber 13 and the chamber 14 and flows into the chamber 14 to react with the dilute silver nitrate in the chamber 14 to form silver chloride which is apparent to the student through the package 10 as a white precipitate.

The package 10 is preferably formed and filled with the reagents using the apparatus and method described in U.S. Pat. No. 6,342,123 B1 issued Jan. 29, 2002 to Rees et al. The '123 patent teaches how to form a relatively weak seal (a “differentially frangible seal” in the language of the '123 patent) between chambers filled with different liquids or other materials. However, it should be understood that although it is preferable to form a “differentially frangible seal” between the chambers, the seal strength around the periphery of the chambers can be the same between the chambers as elsewhere: (a) if the distance between the edges of the chambers is small relative to the distance between the edges of the chambers and the nearest edge of the package (or the edge of another chamber with which flow is not desired); and (b) if the seal strength is sufficiently weak to allow seal breakage between the chambers when the chamber is pressed. Preferably, the chambers to be pressed are about the size of a thumb print, i.e., about one centimeter in diameter, so that essentially complete transfer of the fluid from the chamber occurs when the chamber is pressed.

The preferred material for the upper and lower flexible sheets of the instant invention is Surlyn brand polymer from DuPont because of its toughness, its clarity, its chemical resistance and its ability to form the preferred “differentially frangible seal” between the chambers. However, it should be understood that many different materials can be used in the flexible sheet material of instant invention such as thermoplastic urethane resins (available, for example, from The Dow Chemical Company, Midland Mich.) as well as more common thermoplastic polymers such a polyethylene, polypropylene and polyester. In addition, at least one of the flexible sheets must be sufficiently clear (or at least translucent) to observe the reaction product(s) through such sheet. It should also be understood that the flexible sheet material used in the instant invention can be multi-layered so that, for example, one layer has desirable barrier properties while another layer has desirable sealing properties.

Referring now to FIG. 3, therein is shown a top view of a package 20 to be provided in the instant invention having five peripheral reagent chambers and a central reaction chamber 26. As in the package shown in FIG. 2, the seal strength between the flexible sheets in the area indicated by the small cross-hatching 27 is relatively weaker than the seal strength in the area indicated by the larger cross-hatching 28. The central reaction chamber 26 is partially filled with a dilute solution of acetic acid and phenolphthalein acid-base indicator. The chambers 21, 22, 23, 24 and 25 are each filled with a dilute solution of sodium hydroxide. The concentration and volume of sodium hydroxide in the chambers 21, 22, 23, 24 and 25 is matched to the concentration and volume of acetic acid in the chamber 26 so that as each chamber 21, 22, 23, 24 and 25 is successively pressed to force its contents into the chamber 26, the acetic acid in the chamber 26 is titrated by the sodium hydroxide in the chambers 21-25 and the endpoint indicated by the color change observed in the chamber 26.

Referring now to FIG. 4, therein is shown a top view of a package 30 to be provided in the instant invention having a chamber 31, a chamber 32 and a chamber 33. As in the package shown in FIG. 2, the seal strength between the flexible sheets in the area indicated by the small cross-hatching 34 is relatively weaker than the seal strength in the area indicated by the larger cross-hatching 35. The chamber 31 is filled with a dilute solution of sodium chloride. The chamber 32 is filled with a dilute solution of silver nitrate. The chamber 33 is filled with a dilute solution of sodium thiosulfate. When chamber 31 is pressed, the dilute solution of sodium chloride is forced into chamber 32 and reacts with the silver nitrate in the chamber 32 to form silver chloride. The silver chloride is apparent to the student as a white precipitate. Then the student presses chamber 33 to force the dilute solution of sodium thiosulfate into the chamber 32. The sodium thiosulfate reacts with the silver chloride precipitate to dissolve the precipitate and cause its disappearance.

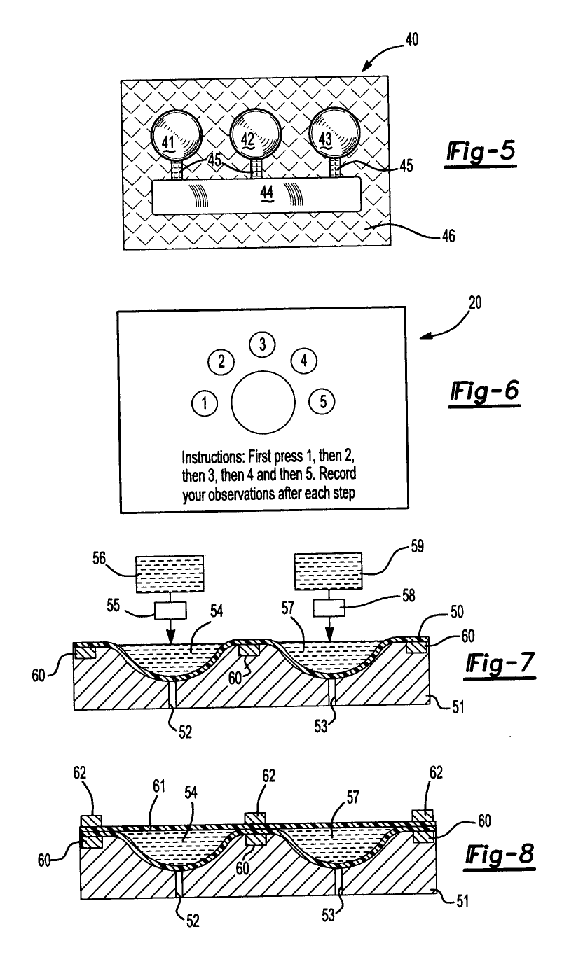

Referring now to FIG. 5, therein is shown a top view of a package 40 to be provided in the instant invention having three reagent chambers 41, 42 and 43 adjacent an elongated reaction chamber 44. As in the package shown in FIG. 2, the seal strength between the flexible sheets in the area indicated by the small cross-hatching 45 is relatively weaker than the seal strength in the area indicated by the larger cross-hatching 46. The chamber 44 can be filled with a reagent or can be empty as desired and the number of reagent chambers can be essentially any number as desired.

Referring now to FIG. 6, therein is shown a top view of the package 20 of FIG. 3. However, in FIG. 6 instructions to the student are shown printed on or between the layers of the package.

Referring now to FIGS. 7 and 8, therein is shown an alternative method for producing a package to be provided in the instant invention. A flexible sheet 50 of Surlyn brand thermoplastic resin has been laid on an aluminum vacuum forming die 51 with vacuum applied to ports 52 and 53 so that the flexible sheet 50 is formed into two one centimeter diameter depressions in the die 51. The first depression is filled with a dilute solution of hydrochloric acid and phenolphthalein 54 by way of automatic measuring and dispensing system 55 from reservoir 56. The second depression is filled with a dilute solution of sodium bicarbonate 57 by way of automatic measuring and dispensing system 58 from reservoir 59. Then a sheet 61 of relatively rigid polypropylene (pigmented with white titanium dioxide pigment to provide a favorable color observation backdrop) is positioned on the filled sheet 50 and heat-sealed thereto by heat-sealers 60 and 62 so that “differentially frangible” seals are formed between the chambers containing the fluid reactant 54 and the fluid reactive component 57.

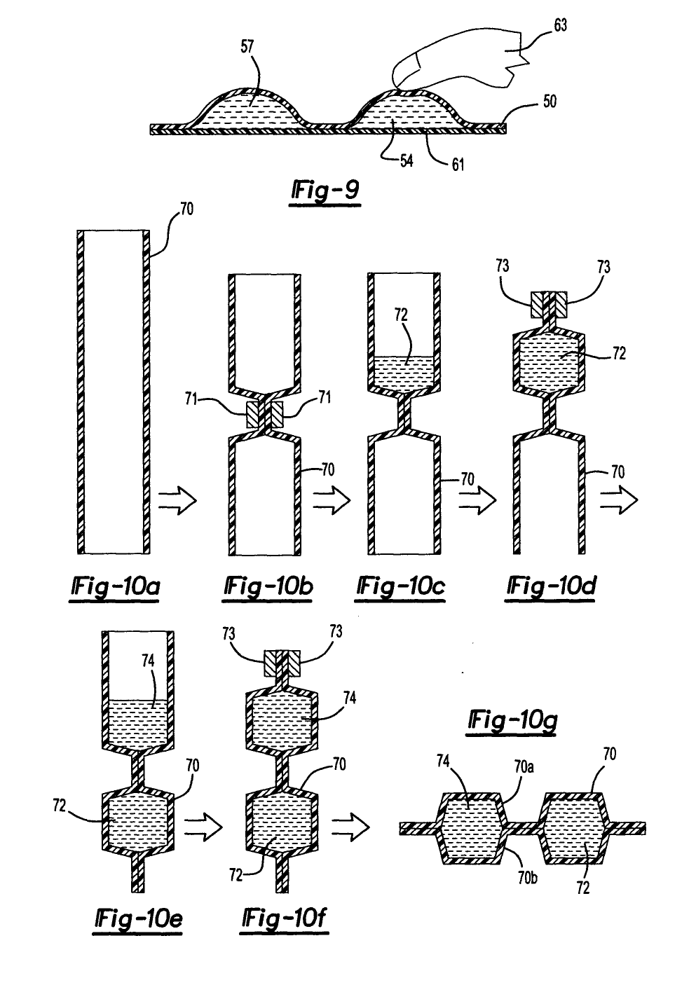

Referring now to FIG. 9, therein is shown the package made by the process discussed above in reference to FIGS. 7 and 8 as provided to a student. FIG. 9 shows the student's finger 63 pressing on the first chamber containing the fluid reactant 54. The package shown in FIG. 9 comprises a flexible sheet 50 and a relatively rigid sheet 61. It should be understood that when a package provided in the instant invention comprises a flexible sheet and a relatively rigid sheet, then the flexible sheet is the “upper sheet” as defined in the following claims.

Referring now to FIG. 10, therein is shown another alternative method for producing a package to be provided in the instant invention. A flexible tube 20 of Surlyn brand thermoplastic resin, as shown in FIG. 10(a), is pinched in its middle portion by heat sealers 71 to seal the sides of the tube together at the middle of the tube 70 as shown in FIG. 10(b) to form a cup shaped section of the tube 70 above and below the middle seal. A first fluid reactant 72 is introduced into the upper cup shaped section of the tube 70 as shown in FIG. 10(c) and then the upper cup shaped section if the tube 70 is heat sealed by heat sealers 73 so that the first fluid reactant 72 is now contained in a closed chamber at the upper end of the tube 70. The tube 70 is then inverted and a reactive component 74 (in liquid form) is introduced into the remaining cup shaped section of the tube 70 as shown in FIG. 10(e) and then heat sealed by heat sealers 73 as shown in FIG. 10(f). The seal made by the heat sealers 71 is a “differentially frangible seal” relative to the seal made by the heat sealers 73. Referring now to FIG. 10(g), it will be understood that even though the tube 70 is a continuous sheet of material, for the purposes of this invention and the following claims, the tube 70 is comprised by an upper sheet 70a and a lower sheet 70b. Although FIG. 10(g) shows a two chamber package to be provided in the instant invention, it will readily be appreciated that packages for the instant invention having more than two chambers can be made from tube sections.

Of course the instant invention is not limited to the specific examples detailed above. Other examples include other acid-base and other precipitation/solution reactions, heterogeneous reactions (such as the reaction of copper with silver nitrate to form silver metal and copper nitrate), endothermic or exothermic reactions (such as the reaction of ammonium chloride powder with water), dissolution reactions (such as the dissolution of foamed polystyrene in acetone), photochemical reactions (such as the darkening of silver chloride precipitate in sunlight), gas forming reactions (such as the reaction of acetic acid with sodium bicarbonate to form carbon dioxide), oxidation-reduction reactions (such as a sequential titration of potassium permanganate with sodium thiosulfate to form a series of colored oxidized manganese species), hydrolysis reactions, polymerization reactions and (without limitation) fermentation reactions.

Referring now to FIGS. 1-10, the package provided in the instant invention must define at least two chambers, as shown, for example, in FIG. 2, but may contain more than two chambers, as shown, for example, in FIGS. 3-5. It should be understood that the first chamber that is pressed is the “first closed chamber” required by the following claims even if such chamber is described in other terms in the above discussion. For example: (a) if the chamber 14 is pressed first in the embodiment shown in FIG. 1, then chamber 14 is the “first closed chamber” required by the following claims, but (b) if the chamber 13 is pressed first in the embodiment shown in FIG. 1, then chamber 13 is the “first closed chamber” required by the following claims.

The description above relates primarily to a number of specific embodiments. However, the disclosure of such specific embodiments is not intended as a limitation of the scope of the instant invention. Thus, it is readily apparent that although the invention has been described in relation with its preferred embodiments and several alternative embodiments, it should be understood that the scope of the instant invention is not limited thereby but is intended to cover all alternatives, modifications and equivalents that are included within the scope of the invention as defined by the following claims.

1. An improved method for students to carry out chemical reactions by mixing a fluid reactant with a reactive component to produce a reaction product, wherein the improvement comprises the step of: providing a package fabricated of upper and lower sheet material defining at least a first closed chamber containing a first fluid reactant and an adjacent second closed chamber containing a reactive component, the package formed by sealing the upper sheet material to the lower sheet material at the periphery of the chambers, at least the upper sheet material being flexible so that when the first chamber is pressed, then the first fluid reactant will break the seal between the first and second chambers and flow into the second chamber to react with the reactive component in the second chamber to produce a reaction product, the reaction product to be observed by the student through the package.

2. The method of claim 1, wherein the reaction product is a colored acid/base indicator.

3. The method of claim 1, wherein the reaction product is a precipitate.

4. The method of claim 1, wherein the reaction product is a metal.

5. The method of claim 1, wherein the reaction product is an inorganic compound.

6. The method of claim 1, wherein the reaction product is an organic compound.

7. The method of claim 1, wherein the reaction product is a gas.

8. The method of claim 1, wherein the reaction product is a result of enzyme catalysis.

9. The method of claim 1, wherein the reaction product is hotter or colder than the reactant immediately prior to the reaction.

10. The method of claim 1, wherein the reaction product is formed slowly enough so that its kinetics of appearance can be determined.

11. The method of claim 1, wherein instructions to the student are printed on or in the package.

12. An improved method for demonstrating chemical reactions to a student by mixing a fluid reactant with a fluid reactive component to produce a reaction product, wherein the improvement comprises the step of: providing a package fabricated of upper and lower sheet material defining at least a first closed chamber containing a first fluid reactant, a second closed chamber containing a first fluid reactive component, the first closed chamber and the second closed chamber each being adjacent a third closed chamber, the package formed by sealing the upper sheet material to the lower sheet material at the periphery of the chambers, at least the upper sheet material being flexible so that when the first chamber is pressed, then the first fluid reactant will break the seal between the first and the third chambers and flow into the third chamber and so that when the second chamber is pressed, then the first fluid reactive component will break the seal between the second and third chambers and flow into the third chamber to react with the first fluid reactant in the third chamber to produce a reaction product, the reaction product to be observed by the student through the package.

13. An article of manufacture, comprising a package fabricated of upper and lower sheet material defining at least a first closed chamber containing a first fluid reactant and an adjacent second closed chamber containing a reactive component, the package formed by sealing the upper sheet material to the lower sheet material at the periphery of the chambers, at least the upper sheet material being flexible so that when the first chamber is pressed, then the first fluid reactant will break the seal between the first and second chambers and flow into the second chamber to react with the reactive component in the second chamber to produce a reaction product, the reaction product selected from the group consisting of a colored acid/base indicator, and a precipitate.

14. An article of manufacture, comprising a a package fabricated of upper and lower sheet material defining at least a first closed chamber containing a first fluid reactant, a second closed chamber containing a first fluid reactive component, the first closed chamber and the second closed chamber each being adjacent a third closed chamber, the package formed by sealing the upper sheet material to the lower sheet material at the periphery of the chambers, at least the upper sheet material being flexible so that when the first chamber is pressed, then the first fluid reactant will break the seal between the first and the third chambers and flow into the third chamber and so that when the second chamber is pressed, then the first fluid reactive component will break the seal between the second and third chambers and flow into the third chamber to react with the first fluid reactant in the third chamber to produce a reaction product, the reaction product, the reaction product selected from the group consisting of a colored acid/base indicator, and a precipitate.
